(19) United States
(12) Patent Application Publication
(10) Pub. No.: US 2026/0137585 A1
(43) Pub. Date: May 21, 2026

(54) MULTI-FUNCTIONAL FACIAL ROLLER DEVICE

(71) Applicant: Birch Strategic Capital, LLC, Laguna Beach, CA (US)

(72) Inventor: Toni Battaglia, North Palm Beach, FL (US)

(21) Appl. No.: 18/953,210

(22) Filed: Nov. 20, 2024

(51) Int. Cl. A61H 15/02; A61H 15/00

(52) U.S. Cl. CPC A61H 15/02; A61H 15/0092; A61H 2015/0014; A61H 2015/0071

(57) ABSTRACT

The present disclosure provides devices and methods for dermal stimulation. The device can include a dermal stimulation device comprising a roller head having a central axis, an inner cavity, and inner surface and an outer surface. The outer surface can be configured to permit the passage of light. The inner surface can comprise a plurality of light emitting elements. The dermal stimulation device can comprise an elongate handle. The elongate handle can comprise a proximal mounting element configured to attach the roller head to the proximal end of the elongate handle. The elongate handle can comprise an actuatable element configured to actuate one or more electrical components housed within the elongate handle.

### TECHNICAL FIELD

The present invention relates to dermal stimulation devices and methods for stimulating the skin.

### BACKGROUND

Skin care tools provide many benefits for overall skin health, skin aesthetic appearance, and overall wellness. Many at-home skin care tools are available to consumers for enhancing their skin health and overall wellness as well as augmenting to an overall self-care practice or routine. Skin care tools can include facial rollers, at-home light therapy applicators, and the like. In particular, facial rollers offer an easy to use at home option for administering the beneficial effects of roller stimulation as a part of a daily routine. Facial rollers are believed to offer many benefits including improved lymphatic flow and drainage, improved blood flow, reduced puffiness, reduced inflammation, cooling and smoothing skin, providing a relaxation effect, reducing stress, and distributing skincare products more evenly than without a roller. Traditional facial rollers can be constructed of natural materials including naturally occurring rocks or stones such as quartz or jade.

In addition to facial rollers, facial tools for administering light therapy can also offer overall wellness and skin health benefits. Red light therapy may work in skin health to: stimulate collagen production, which gives skin its structure, strength and elasticity; increase fibroblast production, which makes collagen. Collagen is a component of connective tissue that builds skin, increase blood circulation to the tissue, reduce inflammation in cells, and/or the like. It is currently being used clinically to improve wound healing, reduce stretch marks, reduce wrinkles, fine lines and age spots, improve facial texture, improve skin conditions like psoriasis, rosacea, and eczema, improve scar, improve sun-damaged skin, improve acne, and the like.

Furthermore, it is increasingly appreciated that mechanical stimulation of the skin helps promote production of collagen and elastin and can also promote activation of lipolysis. The use of mechanical stimulation in the form of vibrations or waves including waves such as low frequency ultrasound waves have been used to apply to mechanical stimulation to the skin of subjects in various locations.

While having multiple tools available provide useful options for skin care wellness, there is a need for multifunctional tools can offer time-saving benefits, greater user convenience, and multiple therapeutic benefits.

### SUMMARY

In meeting the long-felt needs described above, the present disclosure provides a multifunctional facial roller device having both roller functions as well as microcurrent stimulation functions.

In some embodiments the present disclosure provides a dermal stimulation device comprising a roller head having a central axis, an inner cavity, and inner surface and an outer surface, wherein the outer surface is configured to permit the passage of light, and wherein the inner surface houses a plurality of light emitting elements, and an elongate handle comprising; a proximal mounting element configured to attach the roller head to the proximal end of the elongate handle, and an actuatable element configured to actuate one or more electrical components housed within the elongate handle.

In certain aspects, the present disclosure provides a method for stimulating the skin of a subject comprising: contacting a portion of the skin of the subject with the dermal stimulation device of any one of the previous claims, and actuating the dermal stimulation device to emit light, a sonic stimulation, or a combination thereof for a duration of time.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various aspects discussed in the present document. In the drawings:

FIG. 1A depicts an exemplary multifunctional facial roller device as contemplated herein including a textured roller head.

FIG. 1B depicts an exemplary multifunctional facial roller device as contemplated herein with the lights housed within the roller head actuated.

FIG. 1C depicts an exemplary multifunctional facial roller device as contemplated herein including a textured roller head with the light emitting elements actuated.

FIG. 2 depicts an expanded view of an exemplary multifunction facial roller device as contemplated herein.

FIG. 3 depicts a reverse view of an exemplary multifunctional facial roller device as contemplated herein.

FIG. 4 depicts an exemplary multifunctional facial roller device as contemplated herein including a smooth roller head.

FIG. 5 depicts an exemplary method of the present disclosure.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

The present invention provides dermal stimulation devices and methods for stimulation of the skin of a subject in need thereof. The subject can include a human subject. The skin can include the skin of any suitable surface of the body including for example, the face, neck, chest, hands, arms, legs, feet, torso, abdomen, back, and the like.

### Roller Head

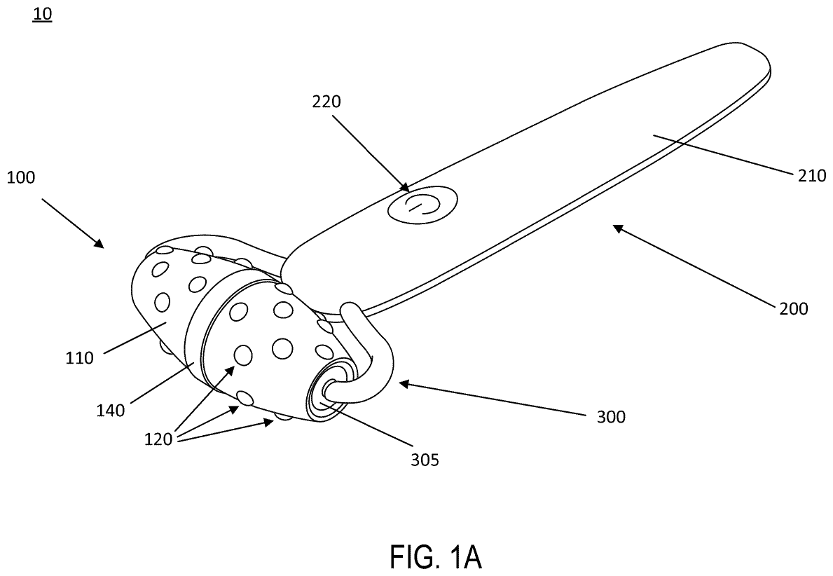

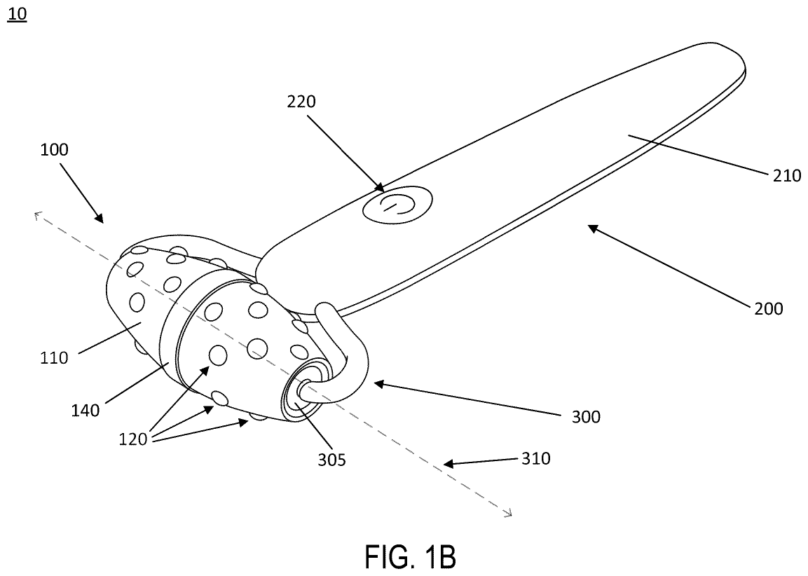

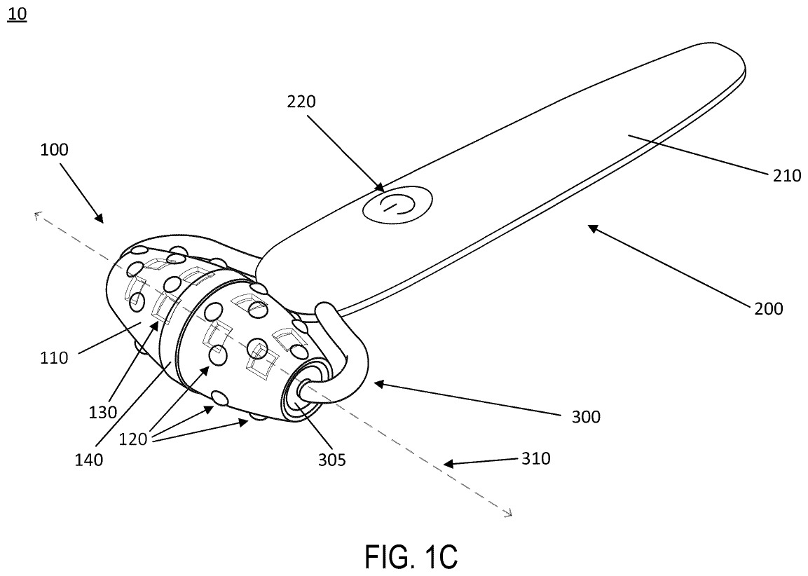

Referring now to FIG. 1A, dermal stimulation device 10 includes a roller head 100 and an elongate handle 200. A mounting element 300 positioned at a proximal end of the elongate handle 200 connects the roller head 100 to the elongate handle 200. As shown in FIG. 1B, the mounting element 300 extends along a central axis 310 through the center of roller head 100. The outer surface 110 (e.g., or outer portion) of roller head 100 can be secured to mounting element 300 with an end piece 305 that allows the outer surface 110 to rotate around the central axis 310 while an inner surface 135 containing one or more light emitting elements 130 remains stationary.

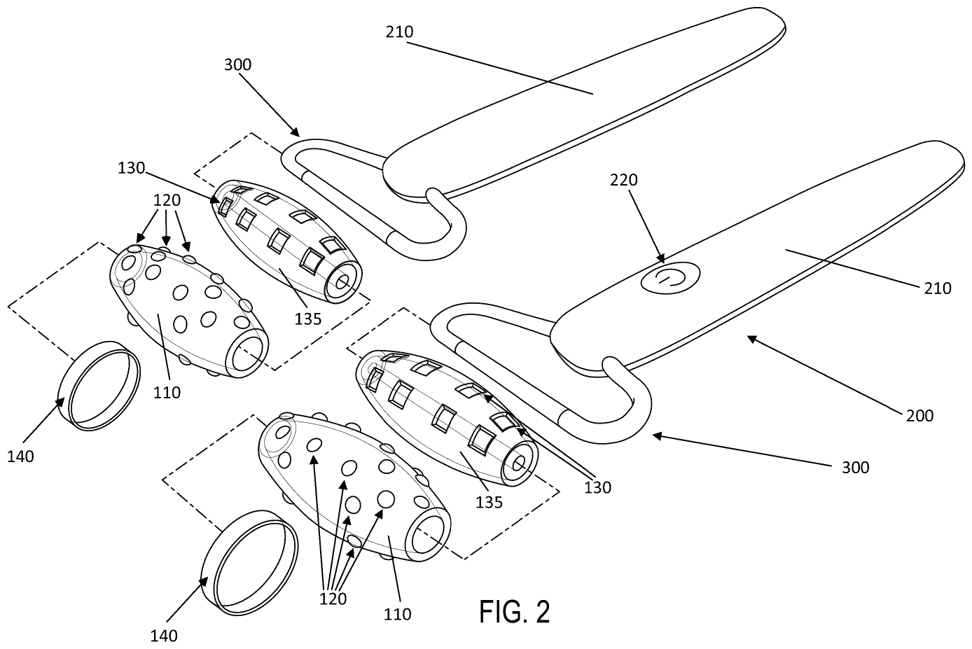

In some embodiments, the roller head 100 includes an inner cavity, an inner surface 135 (e.g., or inner portion) and an outer surface 110. The inner cavity can house one or more connectors, securing mechanisms, and the like. The inner cavity can also house one or more additional electronic elements such as wires, cables, sonic energy conducting or emitting elements, power supplies, microcontrollers and the like. The inner surface houses and/or secures one or more light emitting elements 130, shown in FIG. 1C and FIG. 2. The light emitting elements 130 can include, for example, one or more light emitting diodes (LEDs).

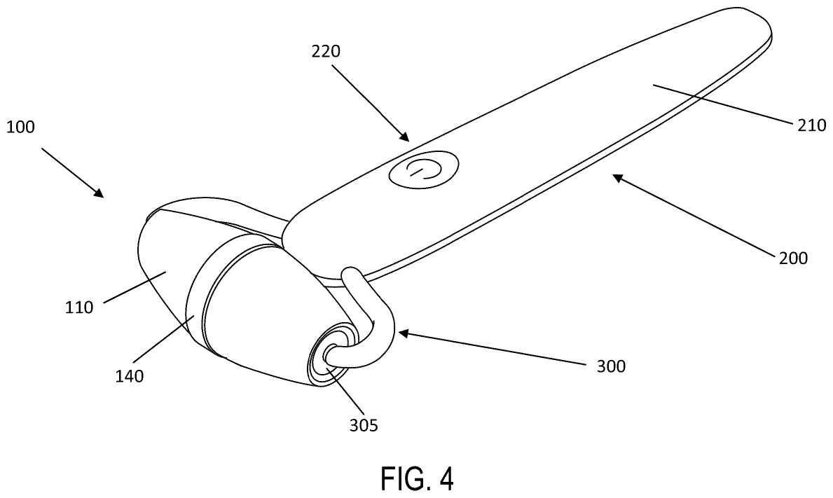

The roller head 100 can include a plurality of texture elements 120. The plurality of texture elements can include one or more ridges, dimples, or a combination thereof. The roller head 100, can have a smooth surface that does not include texture elements, shown in FIG. 4.

In some embodiments, the roller head 100 has a continuous outer surface. In some embodiments, the roller head 100 is a composite of two or more parts fused together along one or more seams. In some embodiments, the roller head 100 is a composite of two or more parts that roll independently of each other.

The roller head 100 can include a central collar 140. The central collar can be constructed of a metal, a plastic, or the like.

In some embodiments, the roller head 100 can be constructed of one or more opaque materials with one or more windows void of material for permitting the passage of light. The roller head 100 can be constructed of one or more sterilizable polymeric materials. For example, in some the roller head 100 can be constructed of one or more of polypropylene, a polycarbonate, a polymethyl methacrylate, a polyvinyl chloride, a polystyrene, a polyethylene terephthalate glycol, an acrylonitrile butadiene styrene, or one or more combinations thereof.

Referring now to FIG. 1C, the outer surface 110 of roller head 100 can be configured to allow the passage of light from one or more light emitting elements 130. In some embodiments, the roller head 100 is constructed of a transparent or translucent material. The transparent or translucent material can include for example, polycarbonate, or other suitable material as understood in the art. In some embodiments, the roller head 100 includes a surface with a plurality of transparent or translucent windows that permit the passage of light. The transparent or translucent windows can be constructed of a transparent or translucent material including, for example, polycarbonate, etc. The roller head 100 can include a composite of one or more opaque materials, and one or more windows of transparent or translucent material.

Referring now to FIG. 2, the inner surface 135 can house or secure one or more light emitting elements 130. The inner surface 135 can be fixed holding the light emitting elements stationary while outer surface 110 can rotate around central axis 310.

The one or more light emitting elements 130 can include an amount of light emitting elements 130 in the range of from about 1 to about 24 light emitting elements. The one or more light emitting elements 130 can include a plurality of light emitting elements including 2, 3, 4, 5, 6, 7, 8, 9, 10, 11, 12, 13, 14, 15, 16, 17, 18, 19, 20, 21, 22, 23, 24 or more light emitting elements. In some embodiments, the light emitting elements 130 can be arranged in one or more patterns. In some embodiments, the light emitting elements are positioned so that the light emitting elements 130 are equally spaced and centered along the central axis of the roller head.

The light emitting elements 130 can emit light having a wavelength in the range of from about 600 nm to about 800 nm. In some embodiments, the light emitting elements 130 can emit light having a wavelength in the range of from about 620 nm to about 750 nm. In some embodiments, the light emitting elements 130 can emit light having a wavelength in the range of from about 630 nm to about 700 nm. In some embodiments, the light emitting elements 130 comprise light having an emission wavelength preferably in the range of from about 620 nm to about 670 nm.

In some embodiments, the light emitting elements 130 are configured for delivering an intensity dose in the range of from about 0.1 J/cm² to about 500 J/cm². For example, the light emitting elements 130 can deliver an intensity dose in the range of from about 0.1 J/cm² to about 1 J/cm², from about 1 J/cm² to about 10 J/cm², from about 10 J/cm² to about 50 J/cm², from about 50 J/cm² to about 100 J/cm², from about 100 J/cm² to about 150 J/cm², from about 150 J/cm² to about 200 J/cm², from about 200 J/cm² to about 250 J/cm², from about 250 J/cm² to about 300 J/cm², from about 300 J/cm² to about 350 J/cm², from about 350 J/cm² to about 400 J/cm², from about 400 J/cm² to about 450 J/cm², from about 450 J/cm² to about 500 J/cm² including any and all increments therebetween.

In some embodiments, the light emitting elements 130 are configured for delivering an irradiance in the range of from about 1 mW/cm² to about 500 mW/cm². For example, the light emitting elements 130 can deliver an irradiance of from about 1 mW/cm² to about 10 mW/cm², from about 10 mW/cm² to about 50 mW/cm², from about 50 mW/cm² to about 100 mW/cm², from about 100 mW/cm² to about 150 mW/cm², from about 150 mW/cm² to about 200 mW/cm², from about 200 mW/cm² to about 250 mW/cm², from about 250 mW/cm² to about 300 mW/cm², from about 300 mW/cm² to about 350 mW/cm², from about 350 mW/cm² to about 400 mW/cm², from about 400 mW/cm² to about 450 mW/cm², from about 450 mW/cm² to about 500 mW/cm² including any and all increments therebetween. In some embodiments, the light emitting elements 130 are configured for delivering an intensity dose in the range of from about 50 mW/cm² to about 70 mW/cm².

In some embodiments, the light emitting elements 130 deliver a pulsed light. In some embodiments, the light emitting elements 130 deliver a continuous light. In some embodiments, the light emitting elements 130 deliver light at a first low level mode setting. In some embodiments, the light emitting elements 130 deliver light at a second medium level mode setting. In some embodiments, the light emitting elements deliver light at a third high level mode setting.

The light emitting elements 130 are actuated (e.g., turned on, turned off, changed from one mode to another) by one or more actuatable elements housed within the elongate handle 200 and electrically connected to the light emitting elements 130 positioned within the roller head 100.

In some embodiments, the light emitting elements are secured on or within inner surface 135 in order to emit light in a fixed direction independent of the position of the outer surface 110 of roller head 100.

In some embodiments, the light emitting elements are configured to emit light in a fixed direction at an angle from the elongate handle. The angle between the primary axis of light emission and the primary axis of the elongate handle can include an angle of approximately 120°. The angle between the primary axis of light emission and the primary axis of the elongate handle can include an angle in the range of from about 100° to about 270°, from about 110° to about 240°, from about 120° to about 180°, including any and all increments therebetween.

In some embodiments, the roller head 100 and/or the elongate handle 210 includes a sonic element. The sonic element can be housed in the internal cavity of the roller head 100. The sonic element can be housed in the elongate body 210. In some embodiments, when actuated, the sonic element produces sonic vibrations or sonic waves. The sonic waves may be emitted from the surface of the roller head 100. In some embodiments, the sonic vibrations or sonic waves have a frequency in the range of from about 5 Hz to about 10,000 Hz. For example, the sonic waves have a frequency in the range of from about 5 Hz to about 10 Hz, from about 10 Hz to about 50 Hz, from about 50 Hz to about 100 Hz, from about 100 Hz to about 500 Hz, from about 500 Hz to about 1000 Hz, from about 1000 Hz to about 1500 Hz, from about 1500 Hz to about 2000 Hz, from about 2000 Hz to about 2500 Hz, from about 2500 Hz to about 3000 Hz, from about 3000 Hz to about 3500 Hz, from about 3500 Hz to about 4000 Hz, from about 4000 Hz to about 4500 Hz, from about 4500 Hz to about 5000 Hz, from about 5000 Hz to about 7500 Hz, from about 7500 Hz to about 10,000 Hz including any and all increments therebetween. The sonic element can be in communication with a sonic actuator housed within the elongate handle 210. The sonic actuator can be controlled by actuator 220 to emit sonic energy in one or more modes including an off mode where no energy is emitted, an on mode, a low mode, a medium mode, a high mode, a pulse mode, or one or more combinations thereof. The one or more modes can be actuated be pressing actuator button 220 one or more times to advance the sonic element mode to a preferred mode. For example, each of the modes can be actuated in sequence. The actuator button 220 can also turn the sonic element on or off.

### Elongate Handle

The elongate handle 200 includes an outer surface 210 and an internal cavity. The outer surface can include one or more depressible actuator buttons 220. The one or more depressible actuator buttons can be positioned on the outer surface of the elongate handle. In some embodiments, the one or more depressible actuator buttons are positioned towards the proximal end of the elongate handle 200 for easy actuating when the elongate handle 200 is being gripped. In some embodiments, the outer surface 210 of the elongate handle 200 and/or the actuator button 220 can include one or more indicator lights for indicating actuation of one or more features including for example, the plurality of light emitting elements 130, the sonic element, or a combination thereof. In some embodiments, the one or more indicator lights can indicate a high mode, medium mode, or low mode of the sonic elements has been actuated. In some embodiments, the one or more indicator lights can indicate a high mode, medium mode, or low mode of the light emitting elements 130 has been actuated.

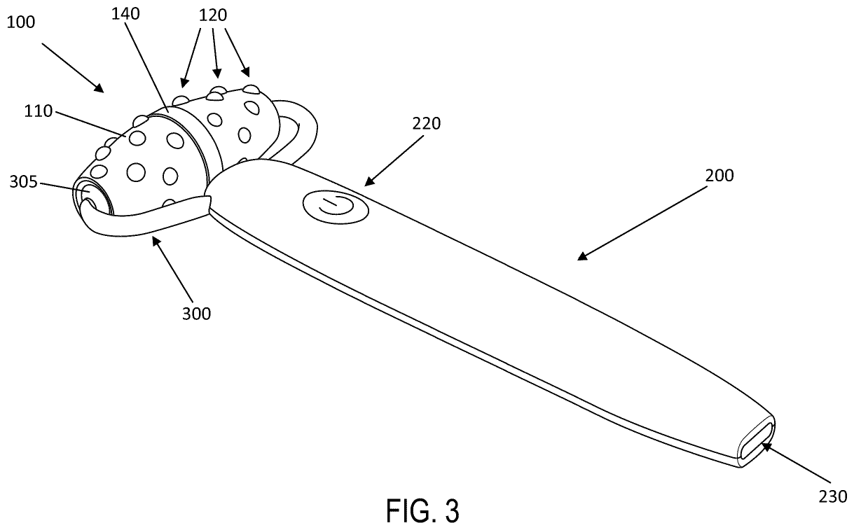

In some embodiments, the internal cavity of elongate handle 200 houses one or more electronic elements. The one or more electronic elements can include one or more power supplies (e.g., battery, rechargeable battery), one or more sonic energy generators, one or more wires, cables, one or more additional electronic elements, conducting elements, or the like, including one or more combinations thereof. The one or more electronic elements can be powered or charged by an external electronic connection that can connect to elongate handle by way of one or more electronic ports 230 (shown in FIG. 3). In some embodiments, one or more wires, cables, one or more additional electronic elements, conducting elements extend from the internal cavity of elongate handle 200 to the roller head 100 connecting the one or more power supplies, sonic energy generators or the like to the one or more light emitting elements and/or sonic elements in the roller head 200. In some embodiments, the one or more power supplies, sonic energy generators or the like connect in a wireless manner to the one or more light emitting elements and/or sonic elements in the roller head 100. In some embodiments, the actuator button 220 actuates the one or more power supplies, the one or more sonic energy generators, or both.

The elongate handle can be constructed of one or more nonconductive materials. The elongate handle can be constructed of one or more sterilizable materials.

### Methods

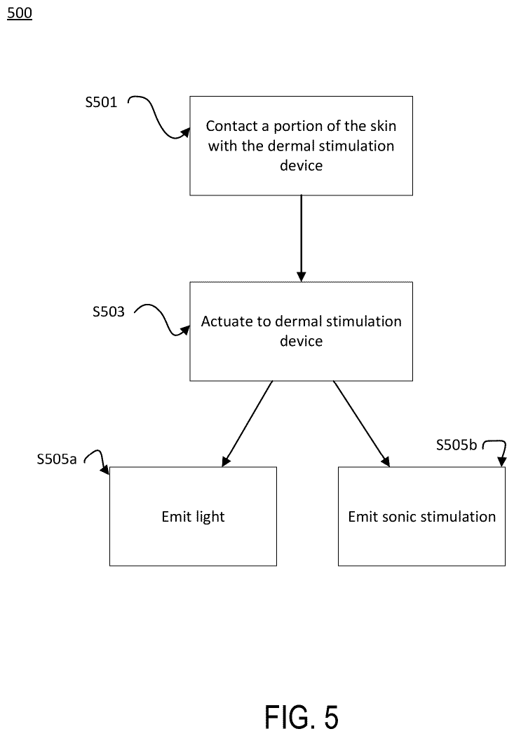

Referring now to FIG. 5, embodiments of the present disclosure provide methods 400 for stimulating the skin of a subject.

Embodiments of method 500 include a step S501. Step S501 includes contacting a portion of the skin of the subject with the dermal stimulation device as described elsewhere herein. The portion of skin can include any suitable portion or surface of skin of the body including, for example, the face, neck, chest, hands, arms, legs, feet, torso, abdomen, back, and the like. The subject can include a human subject.

Embodiments of method 500 can include a step S503. Step S503 includes actuating the dermal stimulation device. In some embodiments, the dermal stimulation device can be actuated to emit one or more signals or stimuli including for example light, sonic simulation, or the like. In some embodiments, the dermal stimulation device can be actuated to emit light. The light can include one or more wavelengths in the range of from about 620 nm to about 750 nm. In some embodiments, the light emitting elements 130 can emit light having a wavelength in the range of from about 630 nm to about 700 nm. In some embodiments, the light emitting elements 130 comprise light having an emission wavelength preferably in the range of from about 620 nm to about 670 nm.

The light can include one or more intensities or irradiances as described herein. For example, the light emitting elements can be actuated to emit a light having an irradiance in the range of from about 1 mW/cm² to about 500 mW/cm². For example, the light emitting elements 130 can deliver an irradiance of from about 1 mW/cm² to about 10 mW/cm², from about 10 mW/cm² to about 50 mW/cm², from about 50 mW/cm² to about 100 mW/cm², from about 100 mW/cm² to about 150 mW/cm², from about 150 mW/cm² to about 200 mW/cm², from about 200 mW/cm² to about 250 mW/cm², from about 250 mW/cm² to about 300 mW/cm², from about 300 mW/cm² to about 350 mW/cm², from about 350 mW/cm² to about 400 mW/cm², from about 400 mW/cm² to about 450 mW/cm², from about 450 mW/cm² to about 500 mW/cm² including any and all increments therebetween. In preferred embodiments, the light emitting elements 130 can be actuated to emit an irradiance in the range of from about 50 mW/cm² to about 70 mW/cm².

In some embodiments, the dermal stimulation device can be actuated to emit a sonic stimulation. The sonic stimulation can include one or more sonic stimuli as described herein. For example, the sonic element can be actuated to emit sonic vibrations or sonic waves on the surface of the roller head 100 having a frequency in the range of from about 5 Hz to about 10,000 Hz. For example, the sonic waves have a frequency in the range of from about 5 Hz to about 10 Hz, from about 10 Hz to about 50 Hz, from about 50 Hz to about 100 Hz, from about 100 Hz to about 500 Hz, from about 500 Hz to about 1000 Hz, from about 1000 Hz to about 1500 Hz, from about 1500 Hz to about 2000 Hz, from about 2000 Hz to about 2500 Hz, from about 2500 Hz to about 3000 Hz, from about 3000 Hz to about 3500 Hz, from about 3500 Hz to about 4000 Hz, from about 4000 Hz to about 4500 Hz, from about 4500 Hz to about 5000 Hz, from about 5000 Hz to about 7500 Hz, from about 7500 Hz to about 10,000 Hz including any and all increments therebetween.

In some embodiments, the dermal stimulation device can be actuated to emit one or more combinations of light and/or sonic stimulation. The stimulation can include a continuous stimulation. The stimulation can include a pulsed stimulation.

The dermal stimulation device can be actuated to emit one or more of light and/or sonic stimulation for a duration of time. The duration of time can be the same for each of the signals or stimuli. The duration of time can be different for each of the signals or stimuli. The duration of time can include up to about 1 second, from about 1 second to about 20 seconds, from about 20 seconds to about 40 seconds, from about 40 seconds to about 60 seconds, from about 60 seconds to about 2 minutes, from about 2 minutes to about 5 minutes, or more than 5 minutes, including any and all increments therebetween.

### Aspects

The following Aspects are illustrative only and do not limit the scope of the present disclosure or the appended claims. Any part or parts of any one or more Aspects can be combined with any part or parts of any one or more other Aspects.

Aspect 1. A dermal stimulation device comprising: a roller head having a central axis, an inner cavity and an outer surface, wherein the outer surface is configured to permit the passage of light, and wherein the inner cavity houses a plurality of light emitting elements, and an elongate handle comprising; a proximal mounting element configured to attach the roller head to the proximal end of the elongate handle, and an actuatable element configured to actuate one or more electrical components housed within the elongate handle.

Aspect 2. The dermal stimulation device of Aspect 1, wherein the roller head further comprises a sonic element in communication with a sonic actuator housed within the elongate handle, the sonic element configured for emitting sonic waves.

Aspect 3. The dermal stimulation device of any one of Aspects 1 or 2, wherein the sonic waves have a frequency in the range of from about 50 Hz to about 10,000 Hz.

Aspect 4. The dermal stimulation device of any one of Aspects 1 to 3, wherein the plurality of light emitting elements comprises an amount in the range of from about 2 to about 12 light emitting elements.

Aspect 5. The dermal stimulation device of any one of Aspects 1 to 4, wherein the light emitting elements are configured to emit light in a fixed direction independent of the position of the roller head.

Aspect 6. The dermal stimulation device of any one of Aspects 1 to 5, wherein the light emitting elements are positioned so that the light emitting elements are equally spaced and centered along the central axis of the roller head.

Aspect 7. The dermal stimulation device of any one of Aspects 1 to 6, wherein the light emitting elements comprise light having an emission wavelength in the range of from about 620 nm to about 750 nm, preferably in the range of from about 620 nm to about 670 nm.

Aspect 8. The dermal stimulation device of any one of Aspects 1 to 7, wherein the light emitting elements are configured for delivering an intensity dose in the range of from about 0.1 J/cm² to about 500 J/cm².

Aspect 9. The dermal stimulation device of any one of Aspects 1 to 8, wherein the light emitting elements deliver a pulsed light.

Aspect 10. The dermal stimulation device of Aspect 9, wherein the pulsed light is pulsed according to one or more patterns comprising one or more combinations of pulse durations and pulse frequencies.

Aspect 11. The dermal stimulation device of any one of Aspects 1 to 8, wherein the light emitting elements deliver a continuous light.

Aspect 12. The dermal stimulation device of any one of Aspects 1 to 11, where the roller head comprises a plurality of texture elements.

Aspect 13. The dermal stimulation device of Aspect 12, wherein the plurality of texture elements comprise one or more ridges, dimples, or a combination thereof.

Aspect 14. The dermal stimulation device of any one of Aspects 1 to 13, wherein the actuatable element is configured to reversibly actuate one or more of the light emitting elements.

Aspect 15. The dermal stimulation device of Aspect 2, wherein the actuatable element is configured to reversibly actuate the sonic element.

Aspect 16. The dermal stimulation device of any one of Aspects 1 to 15, wherein the actuatable element comprises one or more visual indications corresponding to one or more actuation modes comprising: an off mode, a sonic mode, a continuous light mode, and/or one or more pulsed light modes.

Aspect 17. The dermal stimulation device of any one of Aspects 1 to 16, wherein the roller head is constructed of one or more sterilizable polymeric materials comprising polypropylene, a polycarbonate, a polymethyl methacrylate, a polyvinyl chloride, a polystyrene, a polyethylene terephthalate glycol, an acrylonitrile butadiene styrene, or one or more combinations thereof.

Aspect 18. The dermal stimulation device of any one of Aspects 1 to 17, wherein the elongate handle is constructed of one or more nonconductive materials.

Aspect 19. The dermal stimulation device of Aspect 1, wherein the roller head comprises a left segment and a right segment divided by a central link, wherein the left and right segment roll synchronously.

Aspect 20. A method for stimulating the skin of a subject comprising: contacting a portion of the skin of the subject with the dermal stimulation device of any one of the previous Aspects, and actuating the dermal stimulation device to emit light, a sonic stimulation, or a combination thereof for a duration of time.

What is claimed:

1. A dermal stimulation device comprising:
a roller head having a central axis, an inner cavity, an inner surface and an outer surface,
wherein the outer surface is configured to permit the passage of light, and
wherein the inner surface houses a plurality of light emitting elements, and an elongate handle comprising:
a proximal mounting element configured to attach the roller head to the proximal end of the elongate handle, and
an actuatable element configured to actuate one or more electrical components housed within the elongate handle.

2. The dermal stimulation device of claim 1, wherein the roller head further comprises a sonic element in communication with a sonic actuator housed within the elongate handle, the sonic element configured for emitting sonic waves.

3. The dermal stimulation device of claim 1, wherein the sonic waves have a frequency in the range of from about 50 Hz to about 10,000 Hz.

4. The dermal stimulation device of claim 1, wherein the plurality of light emitting elements comprises an amount in the range of from about 2 to about 12 light emitting elements.

5. The dermal stimulation device of claim 1, wherein the light emitting elements are configured to emit light in a fixed direction independent of the position of the roller head.

6. The dermal stimulation device of claim 1, wherein the light emitting elements are positioned so that the light emitting elements are equally spaced and centered along the central axis of the roller head.

7. The dermal stimulation device of claim 1, wherein the light emitting elements comprise light having an emission wavelength in the range of from about 620 nm to about 750 nm, preferably in the range of from about 620 nm to about 670 nm.

8. The dermal stimulation device of claim 1, wherein the light emitting elements are configured for delivering an intensity dose in the range of from about 0.1 J/cm² to about 500 J/cm².

9. The dermal stimulation device of claim 1, wherein the light emitting elements deliver a pulsed light.

10. The dermal stimulation device of claim 9, wherein the pulsed light is pulsed according to one or more patterns comprising one or more combinations of pulse durations and pulse frequencies.

11. The dermal stimulation device of claim 1, wherein the light emitting elements deliver a continuous light.

12. The dermal stimulation device of claim 1, where the roller head comprises a plurality of texture elements.

13. The dermal stimulation device of claim 12, wherein the plurality of texture elements comprise one or more ridges, dimples, or a combination thereof.

14. The dermal stimulation device of claim 1, wherein the actuatable element is configured to reversibly actuate one or more of the light emitting elements.

15. The dermal stimulation device of claim 2, wherein the actuatable element is configured to reversibly actuate the sonic element.

16. The dermal stimulation device of claim 1, wherein the actuatable element comprises one or more visual indications corresponding to one or more actuation modes comprising: an off mode, a sonic mode, a continuous light mode, and/or one or more pulsed light modes.

17. The dermal stimulation device of claim 1, wherein the roller head is constructed of one or more sterilizable polymeric materials comprising polypropylene, a polycarbonate, a polymethyl methacrylate, a polyvinyl chloride, a polystyrene, a polyethylene terephthalate glycol, an acrylonitrile butadiene styrene, or one or more combinations thereof.

18. The dermal stimulation device of claim 1, wherein the elongate handle is constructed of one or more nonconductive materials.

19. The dermal stimulation device of claim 1, wherein the roller head comprises a left segment and a right segment divided by a central link, wherein the left and right segment roll synchronously.

20. A method for stimulating the skin of a subject comprising:
contacting a portion of the skin of the subject with the dermal stimulation device of claim 1, and
actuating the dermal stimulation device to emit light, a sonic stimulation, or a combination thereof for a duration of time.
